(19) United States
(12) Patent Application Publication
(10) Pub. No.: US 2004/0242816 A1
(43) Pub. Date: Dec. 2, 2004

(54) Method for the production of a polymer conversion product by means of metal catalysis

(76) Inventors: Yvonne Heischkel, Mannheim (DE); Nicolas Stockel, Munchen (DE); Oskar Nuyken, Munchen (DE); Rainer Jordan, Muenchen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/488,190

(22) PCT Filed: Aug. 23, 2002
(86) PCT No.: PCT/EP02/09469

(30) Foreign Application Priority Data
Sep. 3, 2001 (DE) 101 42 908.8

(51) Int. Cl. C08F 4/80

(52) U.S. Cl. 526/171; 526/303.1; 526/346; 526/317.1; 526/319; 526/335; 526/341

(57) ABSTRACT

In a process for polmerizing a mixture comprising at least one free-radically polymerizable monomer and a transition metal complex whose transition metal is capable of reversibly binding a halogen atom, thus bringing about a change in the oxidation state of the transition metal from a first oxidation state to a second, in the presence of an initiator R-Y, where Y is halogen and R is alkyl, substituted alkyl, cycloalkyl (substituted or unsubstituted), aryl or —CHₙHal₃₋ₙ, where n=0 to 2 and Hal=halogen, in an aqueous system, the transition metal is bound via suitable anchor groups to the hydrophobic part of an amphiphilic polymer which is made up of a hydrophilic part and a hydrophobic part. Also provided are a corresponding transition metal complex, a reaction product which can be prepared by this process and the use of this transition metal complex for preparing reaction products by free-radical polymerization.

The present invention relates to a process for polymerizing a mixture comprising at least one free-radically polymerizable monomer and a transition metal complex whose transition metal is capable of reversibly binding a halogen atom, thus bringing about a change in the oxidation state of the transition metal from a first oxidation state to a second, in the presence of an initiator R-Y, where Y is halogen and R is alkyl, substituted alkyl, cycloalkyl (substituted or unsubstituted), aryl or —CHₙHal₃₋ₙ, where n=0 to 2 and Hal=halogen. The invention further relates to the corresponding transition metal complex, to a reaction product which can be prepared by the process of the present invention and to the use of the transition metal complex of the present invention for preparing reaction products by free-radical polymerization.

The present invention is in the technical field of free-radical polymerization having features which are typical of a living polymerization system, and the process of the present invention is in principle able to provide reaction products or polymers which can have a narrow molecular weight distribution (M_{w}/Mₙ). Furthermore, choice of appropriate monomers and, if desired, successive addition of different monomers make it possible to prepare both unbranched and branched homopolymers and copolymers and also block copolymers.

For some years there has been great interest in processes or process concepts which are suitable for preparing many polymers and make it possible to produce such polymers having a predetermined structure, molecular weight and molecular weight distribution.

One process concept by means of which such polymers having a predetermined structure, molecular weight and molecular weight distribution can be obtained is atom transfer radical polymerization (ATRP). This is a controlled “living” free-radical polymerization. ATRP can be catalyzed by suitable metal complexes. In ATRP catalyzed by metal complexes the polymerization is initiated by, for example, abstraction of a halogen atom from an alkyl halide used as ATRP initiator by the metal complex, forming a free alkyl radical. The alkyl radical subsequently adds onto a free-radically polymerizable monomer in a chain reaction which can be terminated by addition of the halogen atom abstracted by the metal complex (back) onto the living polymer chain. Subsequent renewed abstraction of the halogen atom from the polymer chain makes a further monomer addition possible. This controlled polymerization allows halogen-terminated polymers having a narrow molecular weight distribution to be obtained. The molecular weight is dependent on the initiator concentration.

WO 98/01480 relates, to the synthesis of homopolymers, block copolymers or graft copolymers in which at least one polar group is present and which have a defined structure and a narrow molecular weight distribution by means of ATRP. Here, at least one free-radically polymerizable monomer is reacted with a system comprising a macroinitiator which contains at least one group which can be transferred to form a free radical, a transition metal complex and at least one ligand which coordinates via a σ or π bond to the transition metal. The reaction is carried out in bulk or in an organic solvent. However, the process proceeds at polymerization rates which are unattractive for commercial use.

WO 00/47634 describes a process for preparing an acrylic polymer by ATRP in an organic solvent such as ethyl acetate or o-xylene, in which at least one vinylic monomer is reacted with a suitable transition metal complex and an alkyl halide as initiator. According to WO 00/47634, the reaction rate of the polymerization process is increased by addition of a Lewis acid which is soluble in the reaction mixture.

WO 97/18247 discloses an ATRP process in which the polymerization of free-radically polymerizable monomers is carried out in the presence of an initiator, a transition metal compound and an amount of the conjugate oxidized form of the transition metal compound which is sufficient to deactivate at least part of the free radical initially formed in the polymerization. The polymerization can be carried out in an aqueous medium using monomers which are at least partly soluble in water or using monomers suitable for an emulsion polymerization when the polymerization is carried out in the presence of an emulsifier.

T. Makino et al. Polym. Prep. (Am. Chem. Soc., Div. Polym. Chem.) 39, 288 (1998) disclose an ATRP of methyl methacrylate (MMA) in an aqueous medium under emulsion polymerization conditions. The catalyst used is a copper catalyst (CuBr+bipyridyl), the initiator used is, for example, ethyl 2-bromoisobutyrate and the emulsifier used is dodecyl sulfate. However, the reaction time is long. After 2 hours at 80° C., PMMA is obtained in a yield of 80-90%.

T. Nishikawa et al. Macromolecules 32, 2204 (1999) describe the living free-radical suspension polymerization of methyl methacrylate (MMA) in the presence of PhCOCHCl₂ or CCl₃Br as initiator, the transition metal complex RuCl₂(PPh₃)₃ and optionally Al(OⁱPr)₃ in an aqueous medium. Although the suspension polymerization is faster than the corresponding polymerization in toluene, the reaction time disclosed in FIG. 1 in T. Nishikawa et al. is nevertheless long. After about 5 hours, the conversion (at a polymerization temperature of 80° C.) is only about 75%. A close-to-complete conversion is achieved only after about 18 hours.

It is an object of the present invention to provide a novel process for preparing a polymeric reaction product, which process leads in a simple and controlled manner to homopolymers and copolymers which can be prepared by a free-radical mechanism. Even at low temperatures, it should be possible to achieve a reaction rate which makes the process attractive for commercial use, i.e. complete conversion of the monomers is achieved after comparatively short reaction times. A further object of the invention is to provide a process by means of which it is possible to prepare block copolymers which cannot be obtained in other ways or can be obtained only in an unsatisfactory manner in other ways.

The achievement of this object starts out from a process for polymerizing a mixture comprising at least one free-radically polymerizable monomer and a transition metal complex whose transition metal is capable of reversibly binding a halogen atom, thus bringing about a change in the oxidation state of the transition metal from a first oxidation state to a second, in the presence of an initiator R-Y, where Y is halogen or alkoxy and R is alkyl, substituted alkyl, cycloalkyl (substituted or unsubstituted), aryl or —CHₙHal₃₋ₙ, where n=0 to 2 and Hal=halogen, in an aqueous system.

In the process of the present invention, the transition metal is bound via suitable anchor groups to the hydrophobic part of an amphiphilic polymer which is made up of a hydrophilic part and a hydrophobic part.

In the aqueous system, the amphiphilic polymer forms micelles which are functionalized with the transition metal complex which serves as ATRP catalyst. Since only the hydrophobic part of the amphiphilic polymer is functionalized with the ATRP catalyst, the controlled free-radical polymerization occurs exclusively in the micelles. This novel polymerization process achieves complete monomer conversions at significantly lower polymerization temperatures and significantly shorter polymerization times than in the processes of the prior art. Such an increase in the reaction rate makes it possible for the controlled free-radical polymerization (ATRP) to be carried out economically.

For the purposes of the present invention, the term “reaction product” encompasses both oligomers having a mean molecular weight (Mₙ) of at least 300 g/mol and polymers. The mean molecular weight (Mₙ) is thus generally from 300 to 5 000 000 g/mol, preferably from 500 to 2 000 000 g/mol, particularly preferably from 500 to 1 000 000 g/mol. The molecular weights are determined by GPC in THF using a polystyrene standard.

Although there are no restrictions in respect of the molecular weight distribution, the process of the present invention makes it possible to obtain a reaction product which has a molecular weight distribution M_{w}/Mₙ measured by gel permeation chromatography using polystyrene as standard of≦4, preferably≦3, more preferably≦2, in particular≦1.5 and in some cases even≦1.3. The molecular weights of the reaction product (A) can be controlled within wide limits by choice of the ratio of monomers (a) to the free-radical initiator.

Depending on the way in which the reaction is carried out, the process of the present invention makes it possible to prepare polymers, homopolymers, block or multiblock and gradated (co)polymers, star-shaped polymers, graft copolymers and branched (co)polymers functionalized at the end groups. Furthermore, the reaction product prepared by the process of the present invention can be used as a macroinitiator. In the present context, a macroinitiator is an oligomeric or polymeric compound which has one or more active sites which enable it to be used as initiator in further free-radical polymerization processes. These further free-radical polymerization processes can be any processes known to those skilled in the art for free-radical polymerization and are not restricted to the process of the present invention.

In a preferred embodiment, the present invention provides a process for preparing a polymeric reaction product which is a macroinitiator or a block copolymer.

For the purposes of the present invention, a “block copolymer” is a polymer made up of at least two polymer blocks having a different monomer composition. The expression “polymer blocks having a different monomer composition” means, for the purposes of the present invention, that at least two regions of the block copolymer have at least two blocks having a different monomer composition. For the purposes of the present invention, it is possible for the transition between two blocks to be continuous, i.e. for two blocks to be separated by a zone which has a random or regular sequence of the monomers constituting the blocks. However, it is likewise possible in the context of the present invention for the transition between two blocks to be virtually discontinuous. In the present context, a “virtually discontinuous transition” is a transition zone which has a significantly shorter length than at least one of the blocks separated by the transition zone. In a preferred embodiment of the present invention, the chain length of such a transition zone is less than 1/10, preferably less than 1/20, of the block length of at least one of the blocks separated by the transition zone.

For the purposes of the present invention, the expression “different monomer composition” means that the monomers constituting the respective block differ in at least one feature, for example in the way they are linked to one another, in their conformation or in their constitution. In the process of the present invention, preference is given to preparing block copolymers which have at least two blocks whose monomer composition differs at least in the constitution of the monomers.

For the purposes of the present invention, an aqueous system is a reaction medium which forms a single phase without a macroscopic phase boundary and comprises from 80 to 100% by weight, preferably from 90 to 100% by weight, particularly preferably from 95 to 100% by weight, of water. If the proportion of water is less than 100% by weight, the aqueous system is a mixture of water and one or more water-miscible solvents such as tetrahydrofuran, methanol, ethanol, propanol, butanol, acetone, N-methylpyrrolidone or methyl ethyl ketone.

For the purposes of the present invention, the term “alkyl” refers to both branched and unbranched alkyl radicals (with the exception of C₁- and C₂-alkyl groups).

The expression “aryl” employed below refers, for the purposes of the present invention, to phenyl, naphthyl, phenanthryl, anthracenyl, triphenylenyl, fluoroanthenyl, preferably phenyl and naphthyl, in which each hydrogen atom can be replaced by C₁₋₂₀-alkyl, preferably C₁₋₆-alkyl, particularly preferably methyl, and each hydrogen atom in the respective alkyl radical can in turn be replaced, independently of one another, by a halogen atom, preferably fluorine or chlorine; furthermore, each hydrogen atom in the respective aryl radical can be replaced by C₂₋₂₀-alkenyl, C₂₋₂₀-alkynyl, C₁₋₆-alkoxy, C₁₋₆-alkylthio, C₃₋₈-cycloalkyl, phenyl, phenyl substituted by 1-5 halogen atoms and/or from 1 to 5 C₁₋₄-alkyl radicals, halogen, primary or secondary amino groups. When aryl is phenyl, the phenyl radical can be substituted by from 1 to 5 of the radicals mentioned; when aryl is naphthyl, the naphthyl radical can be substituted by from 1 to 7 of the radicals mentioned. Both phenyl and naphthyl are, if they are substituted at all, preferably substituted by from 1 to 3 substituents. Aryl is preferably phenyl, phenyl substituted by from 1 to 5 fluorine or chlorine atoms, phenyl substituted by from 1 to 3 C₁₋₆-alkyl radicals or from 1 to 3 C₁₋₄-alkoxy radicals or from 1 to 3 phenyl radicals. Aryl is particularly preferably phenyl or tolyl.

The amphiphilic polymer (L^{P}) can generally be any polymer whose hydrophobic part has suitable anchor groups for binding the transition metal complex. Preferred amphiphilic polymers are those selected from among lipids, e.g. phosphoglycerides or glycolipids, polyoxazolines, polyglycols, e.g. polyethylene glycols or polypropylene glycols, poly(meth)acrylamides and polyurethanes whose hydrophobic parts in each case have suitable anchor groups for binding the transition metal. Particular preference is given to polyoxazolines.

The preparation of the suitable amphiphilic polymers is carried out by methods known to those skilled in the art, for example polycondensation, living cationic polymerization, anionic polymerization or controlled free-radical polymerization or other polymerization techniques, using appropriately functionalized monomers.

Suitable anchor groups for the transition metal complex are dependent, inter alia, on the transition metal M used. In the ATRP process, the transition metal complex repeatedly participates in a reversible redox cycle with the initiator and/or the nonliving halogen-terminated end of the polymer and the corresponding free radical formed at one or more growing end(s) of the polymer. Suitable transition metal compounds are thus all transition metal compounds which can participate in this redox cycle with the initiator and/or the nonliving end of the polymer but do not form a direct carbon-metal bond with the polymer chain. Preferred transition metals M are selected from among Ru²⁺, Ru³⁺, Cu⁺, Cu²⁺, Fe²⁺, Fe³⁺, Cr²⁺, Cr³⁺, Mo⁰, Mo⁺, Mo²⁺, Mo³⁺, W²⁺, W³⁺, Rh³⁺, Rh⁴⁺, Co⁺, Co²⁺, Re²⁺, Re³⁺, Ni⁰, Ni⁺, Mn³⁺, Mn⁴⁺, V²⁺, V³⁺, Zn⁺, Zn²⁺, Au⁺, Au²⁺, Ag⁺ and Ag²⁺. Particular preference is given to transition metals selected from among Ru²⁺, Ru³⁺, Mn³⁺, Mn⁴⁺, Cu⁺, Cu²⁺, Ni⁰, Ni⁺, Fe²⁺ and Fe³⁺. Very particular preference is given to Ru²⁺ and Ru³⁺.

Suitable anchor groups are in principle groups which contain at least one nitrogen, oxygen, phosphorus and/or sulfur atom which can coordinate to the transition metal via a σ bond and also groups containing two or more carbon atoms which can coordinate to the transition metal via a π bond. Preference is given to groups of the following formulae, which are generally bound to the polymer via a single bond, a C₂₋₈-alkylene group, an ether, ester or amide function or via another group suitable for coupling the anchor group to the polymer:

-Z′-R¹ (I)

-Z′-(R²-Z′)ₘ-R¹ (II)

where

R¹ is hydrogen, C₁₋₂₀-alkyl, aryl, a heterocyclic compound, C₁₋₆-alkyl which bears a C₁₋₆-alkoxy, C₁₋₄-dialkylamino, C(═Y)R³ or C(═Y)R⁴R⁵ substituent, or QC(═Y)R⁶, where Q is NR⁵ or (preferably) O and R³ is C₁₋₂₀-alkyl, C₁₋₂₀-alkoxy, aryloxy or a heterocyclic radical, R⁴ and R⁵ are each, independently of one another, hydrogen or C₁₋₂₀-alkyl, or R⁴ and R⁵ together form an alkylene group having from 2 to 5 carbon atoms so that a 3- to 6-membered ring is formed, and R⁶ is hydrogen, C₁₋₂₀-alkyl or aryl;

Z′ is O, S, NR⁷, PR⁷, where R⁷ is selected from the same group as R¹;

R² is in each case a divalent group selected from among C₂₋₄-alkylene and C₂₋₄-alkenylene, in which the covalent bonds to the respective Z′ are in vicinal positions or in β-positions, and C₃₋₈-cycloalkanediyl, C₃₋₈-cycloalkenediyl, aryldiyl and heterocyclic diyl compounds, where the covalent bonds to the respective Z′ are in vicinal positions;

m is from 1 to 6.

Further suitable anchor groups are cyclic or heterocyclic compounds which may be aromatic or aliphatic. These are generally bound to the polymer via a single bond, a C₂₋₈-alkylene group, an ether, ester or amide function or via another group which is suitable for coupling the anchor group to the polymer. Condensed systems such as indenyl derivatives or fluorenyl derivatives are also suitable. Preferred carbocyclic anchor groups are aryl or cyclopentadienyl groups, particularly preferably cyclopentadienyl groups which may, if desired, be substituted in addition to the bond to the polymer. Suitable substituents are C₁₋₆-alkyl, C₃₋₈-cycloalkyl, C₂₋₆-alkenyl, C₃₋₈-cycloalkenyl, or aryl radicals whose ring may contain heteroatoms, preferably N or O. Preferred heterocyclic aromatic systems are those containing at least one nitrogen or oxygen atom. Particular preference is given to pyridyl derivatives, very particularly preferably those which are bound to the polymer via the 2, 4 or 6 position, or pyrrole derivatives which are bound to the polymer via the 2 or 5 position. These pyridyl or pyrrole derivatives very particularly preferably have a further substituent. In the case of the pyridyl derivatives, this is preferably in the 2, 4 or 6 position (depending on the position via which the ring is bound to the polymer). The substituent can be a C₁₋₆-alkyl radical, a C₃₋₈-cycloalkyl radical, a C₂₋₆-alkenyl radical, a C₃₋₈-cycloalkenyl radical, or an aryl radical whose ring may contain heteroatoms, preferably N or O. A very particularly preferred pyridyl derivative is, for example, 2,2′-bipyridyl. In the case of the pyrrole derivatives, the further radical is preferably located in the 2 or 5 position (depending on the position via which the pyrrole ring is bound to the polymer). Suitable substituents are those which have already been mentioned in relation to the pyridyl derivatives. Very particular preference is given to, for example, 2,2′-bipyrroles.

The anchor groups are preferably selected from among diphenylphosphine radicals in which the phenyl groups can be substituted or unsubstituted, pyridyl radicals which can be substituted or unsubstituted, in particular bipyridyl radicals such as 2,2′-bipyridyl radicals which are linked to the polymer via one of the pyridyl groups, pyrrole radicals which can be substituted or unsubstituted, in particular bipyrrole radicals such as 2,2′-bipyrrole radicals which are linked to the polymer via one of the pyrrole groups, and cyclopentadienyl radicals which may, if desired, be substituted in addition to the bond to the polymer.

Depending on the oxidation state of the transition metal and the number of coordination sites occupied by the anchor group, the transition metal complex may contain further ligands.

Suitable further ligands are, inter alia, uncharged ligands L. These are generally selected from among the radicals mentioned as anchor groups. Here, a hydrogen atom or a further substituent preferably selected from among C₁₋₆-alkyl, C₃₋₈-cycloalkyl, C₂₋₆-alkenyl, C₃₋₈-cycloalkenyl and aryl radicals whose ring may contain heteroatoms, preferably N or O, takes the place of the linkage to the polymer via a single bond, a C₂₋₈-alkylene group, an ether, ester or amide function or via another group which is suitable for coupling the anchor group to the polymer. Further suitable ligands are acetonitrile, carbon monoxide, ethylenediamine, propylenediamine, ethylene glycol, propylene glycol and diethylene glycol dimethyl ether (diglyme).

Furthermore, anionic ligands X, preferably selected from among halide anions, C₁₋₅-alkoxy groups and C₁₋₅-alkyl groups, are generally present in the transition metal complex. Halides are particularly preferred. Very particular preference is given to chloride and bromide.

The process of the present invention is thus preferably carried out using a transition metal complex having the formula (III),

ML^{P}LₙXₘ (III)

where the symbols have the following meanings:

M is a transition metal, as defined above, very particularly preferably selected from among Ru²⁺, Ru⁺, Mn⁺, Mn⁴⁺, Cu⁺, Cu²⁺, Ni⁰ , Ni⁺, Fe²⁺ and Fe⁺; very particularly preference is given to Ru²⁺ and Ru³⁺;

L^{P} is an amphiphilic polymer whose hydrophobic part as defined above has suitable anchor groups (as defined above) for binding the transition metal, very particularly preferably a polyoxazoline bearing diphenylphosphine radicals as anchor groups;

L is a further ligand as defined above, preferably selected from among triphenyl-phosphine, in which the phenyl groups may be substituted or unsubstituted, substituted or unsubstituted pyridines, e.g. 2,2′-bipyridyl, substituted or unsubstituted pyrroles, e.g. 2,2′-bipyrrole radicals;

X is a halide or a C₁₋₅-alkoxy group or C₁₋₅-alkyl group as defined above; particularly preferably chloride or bromide;

n is an integer from 0 to 4, preferably from 0 to 2;

m is from 0 to 4, preferably from 0 to 3, depending on the valence of the metal in the first oxidation state.

In a very particularly preferred embodiment of the process of the present invention, the transition metal complex is an Ru²⁺ complex formed from a polymer built up of one hydrophilic and one hydrophobic polyoxazoline block, where the hydrophobic polyoxazoline block is functionalized with a diphenylphosphine group, which complexes RuCl₃ or di-t-chlorobis((p-cymene)chlororuthenium(II).

The transition metal complexes used according to the present invention are prepared by reaction of an appropriate transition metal salt, preferably a halide, particularly preferably a chloride or bromide, with the amphiphilic polymer L^{P} bearing anchor groups and with, if desired, further ligands L. The reaction is carried out by methods known to those skilled in the art for preparing transition metal complexes. For example, the desired polymer and the desired metal salt are combined in methanolic solution, stirred for a reaction time which depends on the components used and the solvent is subsequently removed.

Suitable free-radically polymerizable monomers are, in particular, ethylenically unsaturated monomers.

Suitable monomers containing at least one ethylenically unsaturated group are, for example: olefins such as ethylene or propylene, vinyl aromatic monomers such as styrene, divinylbenzene, 2-vinylnaphthalene and 9-vinylanthracene, substituted vinyl aromatic monomers such as p-methylstyrene, α-methylstyrene, o-chlorostyrene, p-chlorostyrene, 2,4-dimethylstyrene, 4-vinylbiphenyl and vinyltoluene, esters derived from vinyl alcohol and monocarboxylic acids having from 1 to 18,carbon atoms, e.g. vinyl acetate, vinyl propionate, vinyl n-butyrate, vinyl laurate and vinyl stearate, anhydrides or esters of α,β-monoethylenically unsaturated monocarboxylic and dicarboxylic acids having from 3 to 6 carbon atoms, e.g., in particular, acrylic acid, methacrylic acid, maleic acid, fumaric acid and itaconic acid, with alkanols having generally from 1 to 20, preferably from 1 to 12, particularly preferably from 1 to 8 and very particularly preferably from 1 to 4, carbon atoms, for example, in particular, methyl, ethyl, n-butyl, isobutyl, tert-butyl and 2-ethyl-hexyl acrylates and methacrylates, dimethyl maleate or n-butyl maleate, or the esters of the abovementioned carboxylic acids with alkoxy compounds, for example ethylene oxide or polyethylene oxide, e.g. ethylene oxide acrylate or methacrylate, the nitriles of the abovementioned α,β-monoethylenically unsaturated carboxylic acids, e.g. acrylonitrile and methacrylonitrile, and also C₄₋₈-conjugated dienes such as 1,3-butadiene and isoprene, and N-vinyl compounds such as N-vinylpyrrolidone and N-vinylformamide.

Possible styrene compounds are compounds of the formula IV:

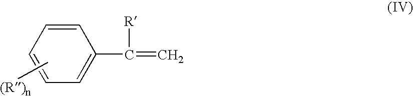

where R′ and R″ are each, independently of one another, H or C₁- to C₈-alkyl and n is 0, 1, 2 or 3.

In the process of the present invention, particular preference is given to using the monomers styrene, α-methylstyrene, divinylbenzene, vinyltoluene, N-vinylpyrrolidone and N-vinylformamide, C₁-C₂₀-alkyl acrylates and C₁-C₂₀-alkyl methacrylates, in particular n-butyl acrylate, 2-ethylhexyl acrylate or methyl methacrylate, and butadiene, also maleic acid and maleic anhydride, acrylonitrile, glycidyl esters and (poly)alkoxylates of acrylic and methacrylic acids, and also monomer mixtures comprising at least 85% by weight of the abovementioned monomers or mixtures of the abovementioned monomers, very particularly preferably styrene and methyl methacrylate.

The present invention accordingly provides, in a preferred embodiment, a process for preparing a polymeric reaction product in which the free-radically polymerizable monomer is selected from the group consisting of:

styrene compounds of the formula (IV)

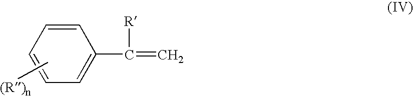

where R′ and R″ are each, independently of one another, H or C₁-C₈-alkyl and n is 0, 1, 2 or 3;

acrylic acid and methacrylic acid and C₁-C₂₀-alkyl esters and C₁-C₁₀₀-alkyloxy esters thereof;

dienes having conjugated double bonds;

ethylenically unsaturated dicarboxylic acids and derivatives thereof;

N-vinyl compounds;

and ethylenically unsaturated nitrile compounds.

Suitable initiators are in principle all initiators used in ATRP catalyzed by transition metals. Preference is given to using initiators of the formula R-Y, where Y is halogen and R is alkyl, substituted alkyl, cycloalkyl (substituted or unsubstituted), aryl or —CHₙHal₃₋ₙ, where n=0 to 2 and Hal=halogen, preferably a bromine or chlorine atom. Preferred initiators are selected from among ethyl 2-bromoisobutyrate, 1-phenylethyl bromide, 1-phenylethyl chloride, p-toluenesulfonyl chloride, benzylhydryl chloride, 1,1,1-trichloroacetone, α,α-dichloroacetophenone, bromotrichloromethane and carbon tetrachloride.

The ratio of transition metal complex to initiator is generally from 1:1 to 1:3, preferably from 1:1.5 to 1:2.5, particularly preferably from 1:1.75 to 1:2.25. The initiator concentration selected has an influence on the molecular weight.

The mixture preferably further comprises, in addition to the transition metal complex, the initiator and the free-radically polymerizable monomer, a cocatalyst in the form of a Lewis acid. Suitable Lewis acids are generally selected from among aluminum compounds, preferably aluminum alkoxylates; metal halides such as ZnHal₂, LiHal, where Hal is a halide, preferably Cl⁻ or Br⁻, FeCl₃; BF₃; acetylacetonate; conjugate organic acids and other organic acids such as camphorsulfonic acid. Preference is given to aluminum alkoxylates, e.g. Al(OⁱPr)₃.

The ratio of the components transition metal complex, initiator, Lewis acid and free-radically polymerizable monomer is generally 0.5-2:1-3:2.5-5:100-400, preferably 0.75-1.5:1.5-2.5:3.5-4.5:150-250, particularly preferably 0.8-1.2:1.8-2.2:3.8-4.2:180-220.

The order of addition of the components used in the process of the present invention can vary. It is possible, for example, to introduce the transition metal complex, the initiator and, if used, the cocatalyst in any order into the aqueous phase and subsequently to add the monomer or monomers. It is also conceivable for the monomer or monomers to be added gradually, either in portions or continuously, or for different monomers to be added sequentially in order to obtain block copolymers, in which case the respective monomer (or monomer mixture) can again be added continuously, in portions or all at once. However, it is also possible to introduce the transition metal complex, any cocatalyst and the monomer or monomers in any order into the aqueous phase and subsequently to add the initiator. It is also conceivable for the initiator to be added not all at once, but gradually (continuously or in portions). Furthermore, it is possible to place the transition metal complex and any cocatalyst in the reaction vessel initially and then to add the initiator and the monomer or monomers all at once or gradually (continuously or in portions).

In addition, the (reaction) mixture can further comprise a chain transfer reagent, e.g. a mercaptan or a catalytic chain transfer compound. Suitable compounds are known to those skilled in the art. Suitable mercaptans are alkyl mercaptans containing at least one —SH group, e.g. butyl mercaptan, nonyl mercaptan and dodecyl mercaptan.

The (reaction) mixture may also further comprise additional additives as are customarily used for modifying the properties of the polymers, e.g. additives to alter the impact toughness of the polymers, dyes and processing aids.

The process of the present invention is carried out in customary reactors (e.g. stirred reactors) under reaction conditions customary for a free-radical polymerization in an aqueous system. In general, the process of the present invention is carried out at temperatures above room temperature and below the decomposition temperature of the monomers used and also below the boiling point of the aqueous phase (depending on the respective reaction pressure and the monomer content). Preference is given to a temperature range from 20 to 140° C., particularly preferably from 20 to 120° C., very particularly preferably from 20 to 100° C. In the process of the present invention, excellent conversions can be achieved even at low temperatures and in short reaction times.

The reaction pressure in the process of the present invention is generally from 1 to 300 bar, preferably from 1 to 100 bar, particularly preferably from 1 to 20 bar.

The reaction times necessary for achieving essentially complete conversion in the process of the present invention are very short. The precise reaction time depends on the amount of initiator. In general, essentially complete conversion of the monomer or monomers used is achieved after from 0.5 to 20 hours, preferably after from 1 to 15 hours, particularly preferably after from 1.5 to 10 hours. For the present purposes, essentially complete conversion means that monomer(s) can no longer be detected by means of NMR spectroscopy.

The present invention further provides a transition metal complex of the formula (III)

ML^{P}LₙXₘ (II)

where the symbols have the following meanings:

M is a transition metal, as defined above, very particularly preferably selected from among Ru²⁺, Ru³⁺, Mn³⁺, Mn⁴⁺, Cu⁺, Cu²⁺, Ni⁰, Ni⁺, Fe²⁺ and Fe³⁺; very particularly preference is given to Ru²⁺ and Ru³⁺;

L^{P} is an amphiphilic polymer whose hydrophobic part as defined above has suitable anchor groups (as defined above) for binding the transition metal, very particularly preferably a polyoxazoline bearing diphenylphosphine radicals as anchor groups;

L is a further ligand as defined above, preferably selected from among triphenylphosphine, in which the phenyl groups may be substituted or unsubstituted, substituted or unsubstituted pyridines, e.g. 2,2′-bipyridyl, substituted or unsubstituted pyrroles, e.g. 2,2′-bipyrrole radicals; L is particularly preferably triphenylphosphine in which the phenyl groups are unsubstituted;

X is a halide or a C₁₋₅-alkoxy group or C₁₋₅-alkyl group as defined above; particularly preferably chloride or bromide;

n is an integer from 0 to 4, preferably from 0 to 2;

m is from 0 to 4, preferably from 0 to 3, depending on the valence of the metal in the first oxidation state.

These complexes are suitable as transition metal catalysts in ATRP in aqueous systems. These transition metal catalysts make possible the ATRP of unsaturated monomers (suitable monomers have been mentioned above) in high yields in short reaction times.

The present invention further provides a reaction product which can be prepared by means of the process of the present invention. Possible reaction products have been specified above. The mean molecular weight (Mₙ) is generally from 300 to 5 000 000 g/mol, preferably from 500 to 2 000 000 g/mol, particularly preferably from 500 to 1 000 000 g/mol. The molecular weights are determined by GPC in THF using a polystyrene standard.

These reaction products preferably have a molecular weight distribution M_{w}/Mₙ measured by gel permeation chromatography using polystyrene as standard of≦4, preferably≦3, more preferably≦2, in particular≦1.5 and in particular cases even≦1.3. The molecular weights of the reaction product can be controlled within wide limits by selection of the ratio of monomers to free-radical initiator.

According to the present invention, the reaction product can be a homopolymer, e.g. polystyrene, poly(styrene-co-maleic anhydride) or a homopolymer made up of (meth)acrylic acid, methyl (meth)acrylates, (meth)acrylates, N-vinylpyrrolidone or olefins, or can be a copolymer comprising blocks made up of polystyrene, poly(styrene-co-maleic anhydride) or polymer units made up of (meth)acrylic acid, methyl (meth)acrylate, (meth)acrylate, N-vinylpyrrolidone or olefins.

The present invention further provides for the use of a reaction product which can be prepared by the process of the present invention or of a reaction product of the present invention for producing binder formulations for coatings and other aqueous systems.

The present invention further provides for the use of transition metal complexes comprising an amphiphilic polymer which is made up of a hydrophilic part and a hydrophobic part and to whose hydrophobic part transition metals, which may optionally bear further ligands, are bound via suitable anchor groups in a process for preparing a reaction product under free-radical conditions in the presence of at least one free-radically polymerizable monomer in an aqueous medium. Suitable amphiphilic polymers, transition metals, further ligands which may be present and monomers and initiators have been mentioned above.

The following examples illustrate the invention.

### EXAMPLES

1. Preparation of a functionalized amphiphilic polyoxazoline

1.1 Monomer syntheses:

2-Methyloxazoline (Aldrich) and 2-hexyloxazoline (Merck) are commercially available compounds.

1.2 Synthesis of functionalized oxazolines:

The synthesis of the functionalized polyoxazolines is carried out by the known methods of Witte and Seeliger.

1.3 Polymer synthesis of the macroligand (polymerization and polymer-analogous functionalization):

1.3.1 Synthesis of the block copolymers

Under a countercurrent of protective gas, a 25-50 mM solution of methyl triflate in acetonitrile is placed in a reaction vessel. The 2-methyl-2-oxazoline is added and the mixture is stirred at a bath temperature of 80° C. for 14 hours.

After cooling, the monomer(s) of the second block is/are added and dry chlorobenzene is added if required. The mixture is stirred at a bath temperature of 90° C. for a further 14 hours.

After the reaction mixture has been cooled, an amount of dry piperidine corresponding to 2.5 times the amount of methyl triflate is added. The resulting mixture is stirred at room temperature for 3 hours and all volatile constituents are distilled off.

The residue is admixed with 3 g of milled and heat-dried potassium carbonate and the amount of chloroform corresponding to the amount of acetonitrile used above. The suspension is stirred overnight. The insoluble constituents are separated off and the choroform solution is precipitated in diethyl ether. The precipitated polymer is separated from the liquid phase by filtration and is dried.

Composition of the polymer obtained (number of repeating units, from ¹H-NMR):

37.4 2-methyloxazoline

5.37 2-hexyloxazoline

4.93 2-(6-(4-iodophenoxy)hexyl)-2-oxazoline calculated molar mass: 5 857 g/mol

1.3.2 Polymer-analogous conversion of the block copolymer precursor into the phosphine-modified macroligand

The polymer precursor (about 2-3 g, 1 equivalent of iodoaromatic), potassium acetate (1.44 equivalents based on the iodoaromatic) and the palladium catalyst (trans-di-(μ-acetato)-bis[o-(di-o-tolylphosphino)benzyl]dipalladium(II), in a molar ratio of 1:500 to the iodoaromatic) are weighed into the reation vessel under inert gas. 10 ml of dry acetonitrile per 1 g of polymer are added. Diphenylphosphine (1.2 equivalents based on the iodoaromatic) is added and the mixture is stirred at 110° C. for at least 36 hours. It is subsequently cooled to room temperature. The conversion is determined by means of ¹H-NMR spectroscopy.

When the conversion is quantitative, all volatile constituents are distilled off. The residue is admixed with 1.5 g of milled potassium carbonate and the amount of dry chloroform corresponding to the volume of acetonitrile used above. The suspension is stirred overnight at room temperature. All insoluble constituents are filtered off. The polymer is purified by repeated precipitation.

The molar mass of the macroligand calculated from the complete conversion established by means of ¹H-NMR is 6 143 g/mol. Each molecule has an average of 4.93 triphenylphosphine functions.

2. Preparation of ruthenium complexes of the functionalized amphiphilic polyoxazoline: complexation of ruthenium(II)

a) Starting from ruthenium(III) chloride:

5/3 equivalents of macroligand are used per equivalent of ruthenium. Complexation is carried out in methanol solution at 40° C. overnight. The solvent is completely removed and a black solid is obtained.

b) Starting from di-μ-chlorobis((p-cymeme)chlororuthenium(II)):

5/3 equivalents of macroligand are used per equivalent of ruthenium. Complexation is carried out in dichloromethane solution at room temperature overnight. The solvent is completely removed and a red solid is obtained.

3. Polymerization experiments

3.1 Example of an ATRP catalyzed in micelles (according to the present invention, experiment A)

Ruthenium complex prepared as described in 2a) or 2b) (1 equivalent), initiator (CCl₄) (2 equivalents), cocatalyst (Al(OiPr)₃) (4 equivalents) and monomer (MMA) are dissolved/suspended in water (about 4 ml of water per 0.1 ml of MMA) under an argon atmosphere.

All liquids are degassed beforehand.

The solution is heated to the reaction temperature (80° C.). The reaction is terminated by sudden cooling using a cooling bath. All volatile constituents are removed and a black solid is obtained. This was examined by GPC (gel permeation chromatography).

3.2 ATRP in a standard system in toluene (comparative experiment; experiment B)

Ruthenium catalyst RuCl₂(PPh₃)₃ (1 equivalent), initiator CCl₄ (2 equivalents), cocatalyst Al(OiPr)₃ (4 equivalents) and monomer MMA (200 equivalents) are dissolved in toluene (7 ml of toluene per g of MMA) under an argon atmosphere.

The mixture is subsequently heated to 80° C. The reaction is terminated by cooling the solution in a cooling bath. All volatile constituents are removed and the solid obtained is examined by GPC.

3.3 ATRP in a standard system in toluene in the presence of an amphiphilic poly(2-oxazoline) (comparative experiment; experiment C)

Components used analogous to “ATRP in a standard system in toluene” under 3.2. In addition, 150 mg of an amphiphilic poly(2-oxazoline) were used. The solid obtained was examined by GPC.

3.4 System for ATRP catalyzed in micelles without ruthenium (comparative experiment; experiment D)

Components used analogous to “ATRP catalyzed in micelles” under 3.1. An amphiphilic poly(2-oxazoline) was used in place of the ruthenium complex.

The table below gives the time to complete conversion of the monomer (in hours (h)) at 80° C. under various conditions (experiments A, B, C and D), and also the mean molecular weights (Mₙ and M_{w} (each in g/mol)) and the polydispersity index (PDI; M_{w}/Mₙ) of the polymers obtained. The mean molecular weights were determined by gel permeation chromatography (GPC).

| | | | | | TABLE |
|---|---|---|---|---|---|
| | | | | | Complete |
| | Temperature/ | Mean molar mass | | | conversion |
| Experiment | ° C. | Mₙ | M_{w} | PDI | after t/h |
| A1¹⁾ | 80 | 49 000 | 115 000 | 2.35 | 3 |
| A2²⁾ | 80 | 22 500 | 70 500 | 3.14 | 3 |
| A3¹⁾ | 80 | 113 000 | 329 000 | 2.90 | 3 |
| A4²⁾ | 80 | 63 000 | 162 000 | 2.57 | 3 |
| B | 80 | 5 200 | 6 900 | 1.32 | 30 |
| C | 80 | 5 000 | 7 100 | 1.41 | 30 |

| | | | |
|---|---|---|---|
| D | 80 | no polymerization | no conversion |

¹⁾The ruthenium complex was prepared as described in 2a); A1 and A3 differ in that the polymerization was carried out at different MMA concentrations;
²⁾The ruthenium complex was prepared as described in 2b); A1 and A3 differ in that the polymerization was carried out at different MMA concentrations.

The process of the present invention achieves complete conversion at significantly shorter polymerization times compared to a polymerization in an organic medium (experiments A and B) at the same temperature (80° C.).

The ATRP catalyzed by a metal complex in toluene is not affected by the amphiphilic polymer (C).

In the absence of the ruthenium complex, no thermal polymerization of MMA occurs (D).

We claim:

1. A process for polymerizing a mixture comprising at least one free-radically polymerizable monomer and a transition metal complex whose transition metal is capable of reversibly binding a halogen atom, thus bringing about a change in the oxidation state of the transition metal from a first oxidation state to a second, in the presence of an initiator R-Y, where Y is halogen and R is alkyl, substituted alkyl, cycloalkyl (substituted or unsubstituted), aryl or —CHₙHal₃₋ₙ, where n=0 to 2 and Hal=halogen, in an aqueous system, wherein the transition metal is bound via suitable anchor groups to the hydrophobic part of an amphiphilic polymer which is made up of a hydrophilic part and a hydrophobic part.

2. A process as claimed in claim 1, wherein the amphiphilic polymer is selected from among lipids, polyoxazolines, polyglycols, poly(meth)acrylamides and polyurethanes whose hydrophobic parts in each case have suitable anchor groups for binding the transition metal.

3. A process as claimed in claim 1 or 2, wherein the transition metal is selected from among Ru²⁺, Ru³⁺, Mn³⁺, Mn⁴⁺, Cu⁺, Cu²⁺, Ni⁰, Ni⁺, Fe²⁺ and Fe³⁺.

4. A process as claimed in any of claims 1 to 3, wherein the anchor groups are preferably selected from among diphenylphosphine radicals in which the phenyl groups can be substituted or unsubstituted, pyridyl radicals which can be substituted or unsubstituted, in particular bipyridyl radicals which are linked to the polymer via one of the pyridyl groups, pyrrole radicals which can be substituted or unsubstituted, in particular bipyrrole radicals which are linked to the polymer via one of the pyrrole groups, and cyclopentadienyl radicals which may, if desired, be substituted in addition to the bond to the polymer.

5. A process as claimed in any of claims 1 to 4, wherein the transition metal complex has the formula (III)
ML^{P}LₙXₘ (III)
where the symbols have the following meanings:
M is a transition metal selected from among Ru²⁺, Ru³⁺, Mn³⁺, Mn⁴⁺, Cu⁺, Cu²⁺, Ni⁰, Ni⁺, Fe²⁺ and Fe³⁺;
L^{P} is an amphiphilic polymer having suitable anchor groups for binding the transition metal;
L is a further ligand selected from among triphenylphosphine, in which the phenyl groups may be substituted or unsubstituted, substituted or unsubstituted pyridines, substituted or unsubstituted pyrroles;
X is a halide or a C₁₋₅-alkoxy group or C₁₋₅-alkyl group; particularly preferably chloride or bromide;
n is an integer from 0 to 4, preferably from 0 to 2;
m is from 0 to 4, preferably from 0 to 3, depending on the valence of the metal in the first oxidation state.

6. A process as claimed in any of claims 1 to 5, wherein the free-radically polymerizable monomer or monomers is/are selected from the group consisting of:
styrene compounds of the formula (IV) 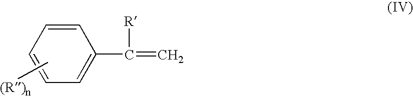
where R′ and R″ are each, independently of one another, H or C₁-C₈-alkyl and n is 0, 1, 2 or 3;
acrylic acid and methacrylic acid and C₁-C₂₀-alkyl esters and C₁-C₁₀₀-alkyloxy esters thereof;
dienes having conjugated double bonds;
ethylenically unsaturated dicarboxylic acids and derivatives thereof;
N-vinyl compounds;
and ethylenically unsaturated nitrile compounds.

7. A process as claimed in any of claims 1 to 6, wherein the initiator R-Y is selected from among ethyl 2-bromoisobutyrate, 1-phenylethyl bromide, 1-phenylethyl chloride, p-toluenesulfonyl chloride, benzylhydryl chloride, 1,1,1-trichloroacetone, α,α-dichloroacetophenone, bromotrichloromethane and carbon tetrachloride.

8. A process as claimed in any of claims 1 to 7, wherein the mixture further comprises, in addition to the transition metal complex, the initiator and the free-radically polymerizable monomer, a cocatalyst in the form of a Lewis acid.

9. A process as claimed in any of claims 1 to 8 carried out in a temperature range from 20 to 140° C.

10. A transition metal complex of the formula (III)
ML^{P}LₙXₘ (III)
where the symbols have the following meanings:
M is a transition metal selected from among Ru²⁺, Ru³⁺, Mn³⁺, Mn⁴⁺, Cu⁺, Cu²⁺, Ni⁰, Ni⁺, Fe²⁺ and Fe³⁺;
L^{P} is an amphiphilic polymer having suitable anchor groups for binding the transition metal;
L is a further ligand selected from among triphenylphosphine, in which the phenyl groups may be substituted or unsubstituted, substituted or unsubstituted pyridines, substituted or unsubstituted pyrroles;
X is a halide or a C₁₋₅-alkoxy group or C₁₋₅-alkyl group; particularly preferably chloride or bromide;
n is an integer from 0 to 4, preferably from 0 to 2;
m is from 0 to 4, preferably from 0 to 3, depending on the valence of the metal in the first oxidation state.

11. A reaction product which can be prepared by means of a process as claimed in any of claims 1 to 9.

12. The use of transition metal complexes comprising an amphiphilic polymer which is made up of a hydrophilic part and a hydrophobic part and to whose hydrophobic part transition metals, which may optionally bear further ligands, are bound via suitable anchor groups in a process for preparing a reaction product under free-radical conditions in the presence of at least one free-radically polymerizable monomer in an aqueous system.
